(19) United States
(12) Patent Application Publication
(10) Pub. No.: US 2002/0117090 A1
(43) Pub. Date: Aug. 29, 2002

(54) Super high strength concrete

(76) Inventor: Richard Ku, Taipei Hsien (TW)

Correspondence Address: LAW OFFICE OF LIAUH & ASSOC., 4224 WAIALAE AVE, STE 5-388, HONOLULU, HI, 96816

(21) Appl. No.: 09/792,211

(22) Filed: Feb. 20, 2001

(51) Int. Cl. C04B 7/13; C04B 14/04

(52) U.S. Cl. 106/737; 106/812; 106/819

(57) ABSTRACT

One kind of super high strength concrete, by adding some zeolites to cement, in order to attain the objective of shortening the time of hydration of cement, so that the concrete shows higher initial compressive strength. Zeolites and cement can undergo the Pozzolanic reaction which results in less void content and higher final compressive strength, so we can get super high strength concrete.

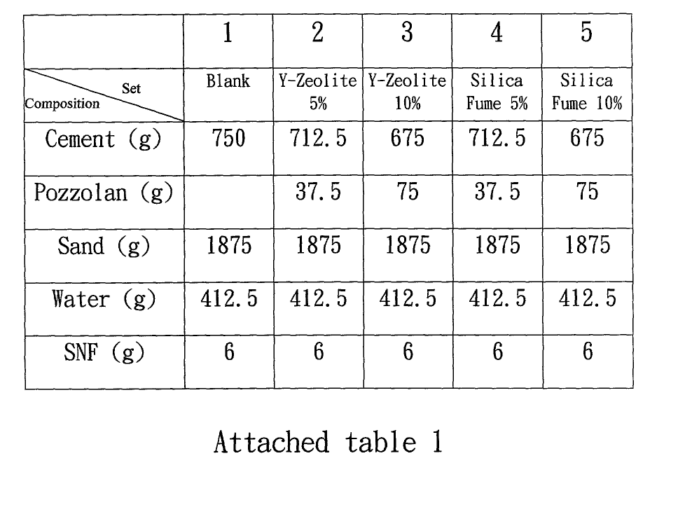

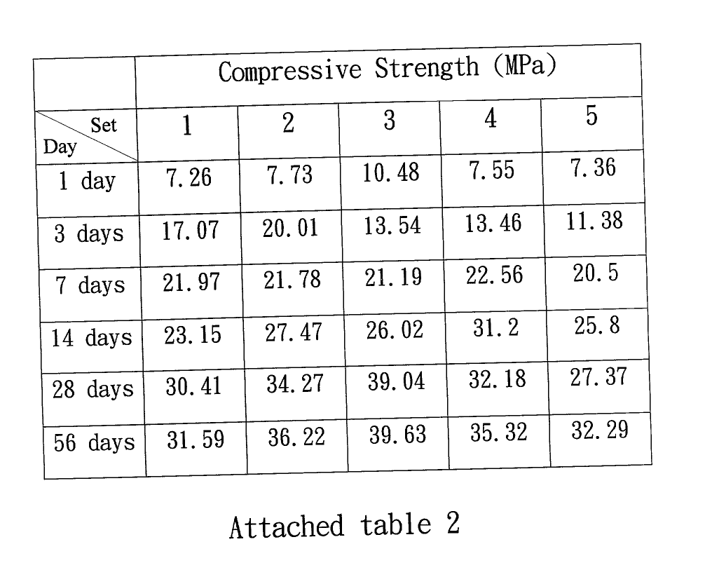

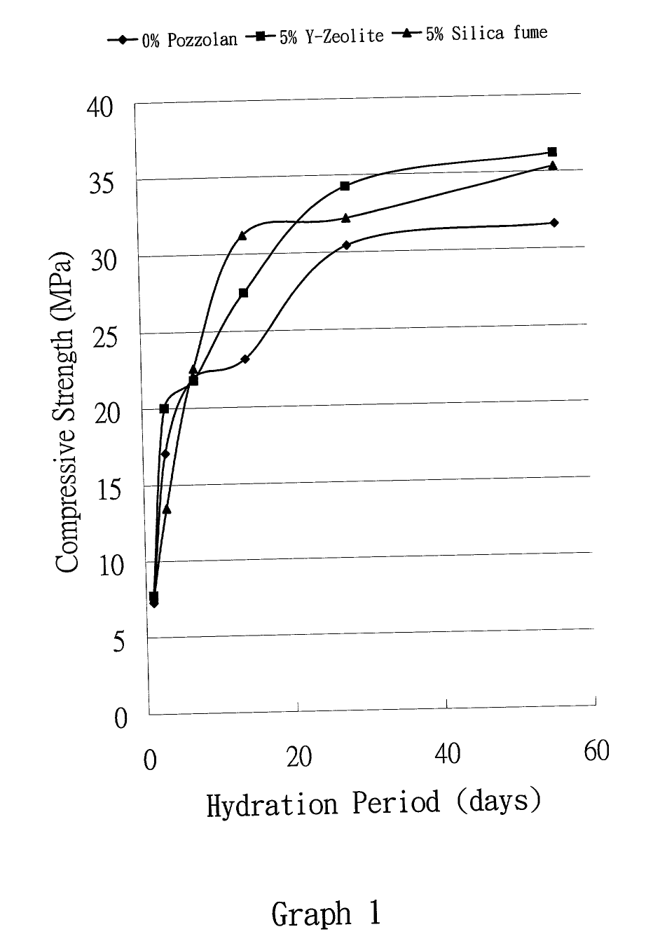

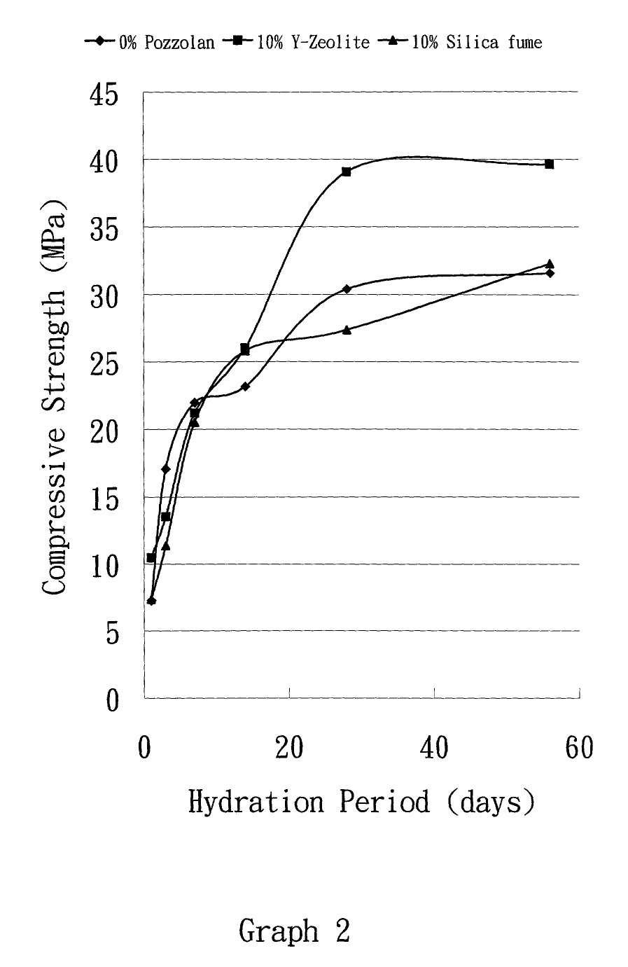

### BACKGROUND OF THE INVENTION

The concrete is one of the most popular construction materials. The greatest difference between concrete and other materials is that concrete can be molded into various structures of a building, such as skyscrapers in America and reservoirs in Taiwan, etc. The concrete costs much less than the other materials and is easy to work with, so it is used widely throughout the world.

The concrete needs some time for the hydration reaction to complete so that concrete buildings can have fixed shapes and good strength. In raining areas such as Taiwan and South-East Asia, and in cold regions such as America, Canada and North Europe, the high moisture or low temperature can prolong the time of cement hydration, and the schedule of the building project will fall behind.

The relative specific strength (the ratio of strength to weight) of concrete is much lower than that of metal construction materials such as steel. This disadvantage makes concrete break easily when the cement is given outside force, and leads to its further degradation which ultimately may affect the safety of the building.

Concrete is usually composed of cement, coarse aggregate, fine aggregate, water, and some additives, and each has its special function and engineering property; so when requiring different functions of concrete in engineering, we can change the proportions of the composing materials.

Water plays a very important role in concrete formation. Water is the solvent for cement, coarse aggregate, fine aggregate, and some additives, so that these materials can mix completely and evenly. Furthermore, water can react with cement to undergo the hydration reaction, and makes the concrete solidify to meet the needs of engineering design. But too much water can remain in the pores of concrete, and when water evaporates from the pores, the void content of concrete increases, making its strength lower, and eventually degradation process of the concrete may affect the safety of the building.

Under the considerations of safety, durability, workability, and economy, different additives can be added into concrete; one of them is Pozzolan that can replace parts of cement to meet the needs of specific engineering designs. The most popular Pozzolan for engineering in the past are fly ash, slag powder, and silica fume. The main components of Pozzolan, such as fly ash, slag powder, and silica fume are SiO₂ or Al₂O₃. The amount of SiO₂ is greater than 90% in the silica fume. Fly ash and slag powder have the advantage of higher achieving final strength of the concrete, but its also prolong the hydration time of cement and thus reduce the initial strength. Silica fume does not reduce the initial strength, but the unit price is quite high.

Among the common Pozzolan, only silica fume can lead to super high strength concrete. The effect of the Pozzolanic reaction produced by mixing cement with silica fume is better than that with fly ash or slag powder. Since the price of silica fume is quite high, it is not used to modify the concrete unless the engineering design demands a concrete of super high strength.

The hydration product of Pozzolan and cement is Ca(OH)₂ which can further undergo the Pozzolanic reaction as follows:

(CH)+A+H→C-A-H

(CH)+S+H→C-S-H

(CH)=Ca(OH)₂ A=Al₂O₃ S=SiO₂ H=H₂O

The hydration product Ca(OH)₂ of cement can react with the SiO₂ and Al₂O₃ of the Pozzolan to produce crystalline C-A-H and low-density C-S-H gel. The formation of the C-S-H gel from the reaction of silica and calcium hydroxide (CH) proceeds very slowly (usually in more than 56 days). When calcium hydroxide (CH) is consumed in the above reaction, more of (CH) will dissolve in water to further undergo this Pozzolanic reaction so that the content of C-S-H gel in cement increases with time, thus increasing the long-term strength and durability of the concrete.

### SUMMARY OF THE INVENTION

This invention uses some zeolites as the Pozzolan of concrete, that is highly reactive and can undergo the Pozzolanic reaction with cement very rapidly and effectively, and thus can decrease the hydration time of cement, increase the initial and final strength of the concrete to reach the standard of super high strength concrete.

This invention provides “super high strength concrete” which uses zeolites as Pozzolan to undergo the Pozzolanic reaction with cement, to produce low-density C-S-H gel which fills up the pores of concrete and increases the strength of concrete.

The cost of zeolites used in this invention is much lower than that of silica fume, and makes the concrete using the zeolites more competitive in construction engineering, and the super high strength concrete can be used more extensively for construction.

### DESCRIPTION OF THE GRAPHS

Attached table 1 is the composition of various concrete materials.

Attached table 2 is the variation of compressive strength of the concrete with time.

Graph 1 is the compressive strength chart of experimental sets 1, 2, and 4.

Graph 2 is the compressive strength chart of experimental sets 1, 3, and 5.

### DETAILED DESCRIPTION OF THE INVENTION

The announcement “super high strength concrete” of this invention uses zeolites as Pozzolan to replace parts of cement. Zeolites can undergo the Pozzolanic reaction with cement rapidly to produce low-density C-S-H gel to fill up the pores of concrete. This kind of low-density C-S-H gel can combine the cement, coarse aggregate, fine aggregate, and other additives to increase the strength of the concrete strongly and uniformly.

The proportion of cement replaced by zeolites is between 0.5-40%. The higher content of the zeolites, the faster the Pozzolanic reaction so that the hydration reaction of concrete proceeds more rapidly and produces more C-S-H gel which with its gluing property can increase the strength of the concrete. But the cement content cannot be too low, for there needs to be enough cement to undergo the Pozzolanic reaction with zeolites.

Zeolite is a combination of irregular crystals of silica (SiO₂) and alumina (Al₂O₃) which are also complexed with some metal cations. The amorphous structures of silica and alumina in zeolite also cause higher reactivity with (CH). The chemical composition of the zeolite can be shown as the following:

M₂/nO.Al₂O₃.xSiO₂.yH₂O

M: metal cations

n: valence of the metal cation

x, y : the number of SiO₂ and H₂O molecules, respectively, (x≧2 in general.)

Some common metal cations are group IA (alkali metal), IIA (alkaline-earth metal), and rare earth metals.

There are many different kinds of zeolites produced in nature, but mordenite and faujasite catch the most attention.

The basic units of faujasite (also named sodalite) are some regular cubic-octahedrons composed of 24 SiO₄⁻⁴ or AlO₄⁻⁵ tetrahedron prisms. There are three different ways to combine these sodalite units to form A-, X- or Y-zeolite.

Many manufacturing processes use these zeolites as industrial catalyst, and the Y-zeolite is mainly used in FCC (fluid catalytic cracking). This invention also uses the Y-zeolite as the Pozzolan to make the super high strength concrete.

That this invention uses zeolites as Pozzolan to increase the strength of concrete is unprecedented. Zeolites contain irregular crystals of alumina and silica which are highly effective to promote the Pozzolanic reaction of cement.

Since the zeolites contain the components of Al₂O₃and SiO₂, when used in Pozzolan they will produce crystal of C-A-H and low-density C-S-H gel in cement. Because calcium hydroxide (CH) is slowly and continuously released in the cement, its reaction with zeolites produces C-S-H gel which leads to the increase of long-term strength (after 56 days) and durability of the concrete.

When zeolites undergo the Pozzolanic reaction with cement, the calcium hydroxide (CH) which is produced by the hydration of cement is consumed. This will cause the cement to further undergo the hydration, so the zeolites can also accelerate the hydration of cement. Thus, when zeolites are used as Pozzolan, they will shorten the time needed for hydration of the cement, and also increase the extent of hydration, so that the initial strength of the concrete is higher. On the other hand, the greater extent of hydration can produce more calcium hydroxide (CH) to react with the zeolites in the Pozzolanic reaction, so that the final strength of the concrete can also be higher than that of normal one.

There is often too much water remaining in the concrete. When water evaporates, it increases the pore volume of the concrete and thus lowers the strength of the concrete. Since zeolites can facilitate the hydration of cement, the water content of the concrete is lowered. Furthermore, zeolites can undergo the Pozzolanic reaction to produce low-density C-S-H gel which fills up the pores of the concrete. The gluing ability of this C-S-H gel also helps to combine the cement, coarse aggregate, fine aggregate, and other additives to increase the strength of concrete strongly and evenly and to produce the super high strength concrete.

High moisture and low temperature can prolong the time of hydration of cement and make the schedule of the building project fall behind. The proportion of water in concrete cannot be too high. Thus the specific gravity of concrete cannot be much lowered (the specific gravity of cement is about 3.1, the specific gravity of aggregate is about 2.6, and the specific gravity of water is about 1). If the proportion of water in concrete is too high, although the concrete will be less heavy, this kind of concrete has more pores and thus lower strength.

This invention uses zeolites which have high activity and cannot only undergo the Pozzolanic reaction with cement rapidly, but also consume lots of water. In this way we can raise the proportion of water in concrete, which helps to lower the specific gravity of the concrete. Since the Pozzolanic reaction can produce low-density C-S-H gel to fill up the pores of concrete, and to combine cement, coarse aggregate, fine aggregate, and some additives, the strength of concrete can be increased strongly and uniformly. Combining the results of reducing the specific gravity and increasing the strength of the concrete, we can obtain concrete of higher relative specific strength (the ratio of strength to weight) which will increase its applicability to suit different needs of construction engineering.

We can use the solid-state nuclear magnetic resonance (NMR) spectrometry and the powder X-ray diffractometry (XRD) to study structural changes by adding silica fume or zeolites to concrete as the Pozzolan.

Although the C-S-H gel is an amorphous substance and thus cannot be analyzed by powder X-ray method, we can use this method to study the change of the amount of calcium hydroxide (CH) during the hydration process of cement.

By using the powder X-ray diffractometry (XRD) to probe into the Pozzolanic reaction of cement with the zeolite or silica fume, the amount of calcium hydroxide (CH) is found to decrease with time. The amorphous C-S-H gel that is produced in the process of the Pozzolanic reaction can be analyzed by the solid-state nuclear magnetic resonance spectrometry.

The examples of the experiments (see the Attached table 1):

The 1st set is Cement 750 g, Sand 1875 g, Water 412.5 g, Superplasticizer (such as Sulphonated Napthalene Formaldehyde, abbreviated as SNF) 6 g.

The 2nd set is Cement 712.5 g, Y-Zeolite 37.5 g, Sand 1875 g, Water 412.5 g, and SNF 6 g.

The 3rd set is Cement 675 g, Y-Zeolite 75 g, Sand 1875 g, Water 412.5 g, and SNF 6 g.

The 4th set is Cement 712.5 g, Silica Fume 37.5 g, Sand 1875 g, Water 412.5 g, and SNF 6 g.

The 5th set is Cement 675 g, Silica Fume 75 g, Sand 1875 g, Water 412.5 g, and SNF 6 g.

A 100-ton compressive machine is used to measure the compressive strength of the above five sets of mortar (Attached table 2). The above results are also drawn as Chart 1 and Chart 2. From these experiments it can be seen that this invention using zeolite can make the strength of mortar higher than that using silica fume. It should also be emphasized that the Y-zeolite used in this invention is much cheaper than the silica fume.

Zeolites are widely used as catalyst in many industrial processes. In a chemical reaction the catalyst is not consumed and can be used repeatedly. But in order to keep the reactivity of a zeolitehigh in an industrial process, it is quite common to add some new zeolite catalysts to replace some used ones. It is proven in this invention that the recycled zeolite catalysts from industry can be used as Pozzolan for concrete. For example, the recycled zeolitewhich is produced by the Fluid Catalytic Cracking (FCC) in oil-refining industry can be used as Pozzolan in this invention. As the consciousness of environmental protection and sustainable development rises in modern times, this invention provides a good example of resources recycling.

I claim:

1) One kind of high strength concrete, which uses zeolite as Pozzolan to replace 0.5-40% of cement, and promotes the Pozzolanic reaction with cement to produce low-density C-S-H gel to fill up the pores of concrete and to combine the various ingredients of the concrete for the production of super high strength concrete.

2) As the 1st item of the range of applying patent stating high strength concrete, the concrete contains cement, coarse aggregate, fine aggregate, zeolite and other additives.

3) As the 1st item of the range of applying patent stating high strength concrete, the zeolite is composed of amorphous Al₂O₃, SiO₂ and metal cations.
